(19) United States
(12) Patent Application Publication
(10) Pub. No.: US 2007/0292102 A1
(43) Pub. Date: Dec. 20, 2007

(54) Image processing method, image processing device, image processing program and image browsing system

(75) Inventor: Ryousuke Usami, Saitama (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/812,211

(22) Filed: Jun. 15, 2007

(30) Foreign Application Priority Data
Jun. 15, 2006 (JP) 2006-165908

(51) Int. Cl. H04N 5/91

(52) U.S. Cl. 386/46

(57) ABSTRACT

A demultiplexing processing section demultiplexes image data from an input movie file. A trimming section trims a predetermined number of forefront frames on the movie file, as a head area, and creates head area image data. A decoding section decodes the head area image data into still image frames arranged in a time series order. A frame extracting section extracts, at constant time intervals, some of the still image frames of the decoded head area image data. The simple movie creating section creates a simple movie file in which the extracted still image frames are arranged and combined in a time series order.

### BACKGROUND OF THE INVENTION

1. Field of the Invention

The present invention relates to an image processing method, an image processing device, an image processing program and an image browsing system, which decode image data of compressed form including a plurality of still image frames, and selectively extract a plurality of still image frames of uncompressed form, and then combine the extracted still image frames in a time series order to create a simple movie data.

2. Description of the Related Arts

In recent years, many mobile phones have a movie recording function with use of an incorporated camera and a reproducing function for the movie. The movie data recorded by the mobile phone can be sent to another mobile phone as an attached file of a mail or other forms. A background of this situation is that 3GPP (standard-setting organization for W-CDMA format) and 3GPP2 (standard-setting organization for CDMA2000 format) set the standard specification of the movie based on MPEG-4 technique with spread of 3G (the third generation) mobile phones, and compatibility between different models and carriers of the mobile phones is increased.

Since the MPEG movie data or such standard format movie data (standard movie data) supports a frame rate of, for example, 15-30 frames/sec, it contains a large number of still image frames, and its file size (data amount) is large generally. In order to compress this large file size movie data at a high compression ratio, the MPEG and other such standards prepare a special image data compression method (i.e., a frame compression method), different from general data compression methods. As is well-known, the frame compression method is divided into an intraframe compression that compresses by checking the redundancy among the pixels in a single frame, and an intraframe compression that compresses by predicting the movements between successive frames.

Recently, high-function mobile phones that can handle the standard movie data are becoming popular on the one hand, there are still a lot of low-function mobile phones that only handles still images or, at best, simple movies such as an animation GIF. The simple movie data supports a lower frame rate than the MPEG movie data, and is not compressed by the frame compression method. Due to such a low frame rate, a photographed subject hardly moves smoothly in the simple movie, and this fact makes the simple movie called a frame-by-frame movie. If an available frame rate is extremely low, the simple movie appears nothing but a slide show or an intermittent display of still images, and thus the simple movie is also called a continuous still image. However, its low frame rate allows the simple image data to be small in size, and the general compression method applied thereto allows the simple movie data to be decoded and reproduced with a little load. Accordingly, the simple movie is largely supported by the low-function mobile phones. Obviously, the low-function mobile phones have a drawback that they can not receive the MPEG movie data from the high-function mobile phones.

As is generally known, there is i-motion mail® system. In this system, a movie file send as an attached file by a sending side mobile phone is temporally stored in a server, a receiving side mobile phone receives a mail including an address of a storage area of the movie file. After the receiving side mobile phone sends a request to the server for browsing the movie, the server deliveries the movie data to the receiving side mobile phone. In case that the server receives a request for browsing the movie from a receiving side mobile phone not compliant with the i-motion mail®, the server converts the movie data into continuous still images and sends them, as a simple movie, to the receiving side mobile phone.

Japanese Patent Laid-open Publication No. 2004-229103 discloses an image distribution system which converts the MPEG movie data, transferred through a data communication network, into an animation GIF and distributes it.

The simple movie data may be produced from the MPEG movie data by firstly applying a demultiplexing process to the movie data composed of multiplexed image data and sound data, so as to separate the image data from the sound data. The separated image data is then decoded, and all the still image frames in the image data are uncompressed. Some still image frames are extracted at regular sampling intervals from all these uncompressed still image frames, and then combined to form a simple movie (see, for example, Japanese Patent Laid-open Publication No. 2004-007138).

According to the disclosure of the publication No. 2004-007138, all the frames in the frame compressed image data are decoded before the still image frames are extracted for the simple movie. However, the decoding process of the frame compressed image data requires time, and it takes a long time to complete the simple movie creating process accordingly.

### SUMMARY OF THE INVENTION

An object of the present invention is to provide an image processing method, an image processing device, an image processing program and an image browsing system which can create a simple movie from compressed image data in a small amount of time.

In order to achieve the above and other objects, an image processing method of the present invention comprises a first to fourth steps. In the first step, a series of still image frames at a head of original image data is trimmed as a head area for creating head area image data of compressed form. The original image data contains a plurality of the still image frames compressed on a frame basis. In the second step, the head area image data of compressed form is decoded into an uncompressed form. In the third step, a plurality of still image frames are extracted at constant time intervals from the head area image data of uncompressed form. In the fourth step, simple movie data is created by arranging and combining the extracted still image frames in a time series order.

Each of the image data has a different size depending on a frame rate, a bit rate, a reproduction time and so on. When the size of the image data is large, the head area is preferably trimmed before decoding to reduce the data size. However, when the size of the image data is small, the head area may need not be trimmed. Therefore, it may be possible that a step of comparing a size of the image data to a threshold value is added before the first step. In this case, the head area is trimmed in the first step only when the size of the image data is larger than the threshold value, so that a size of the head area image data of uncompressed form becomes no more than the threshold value. The threshold value may be either a predetermined fixed value or a variable.

In the first step, it is preferable that a number of still image frames corresponding to a size of the head area image data of uncompressed form is trimmed as the head area, based on a rate between a number of still image frames in the image data and a size of the image data.

An image processing device of the present invention comprises a trimming section, a decoding section, an extracting section and a simple movie creating section. In the trimming section, a series of still image frames at a head of original image data is trimmed as a head area for creating head area image data of compressed form. The original image data contains a plurality of the still image frames compressed on a frame basis. In the decoding section, the head area image data of compressed form is decoded into an uncompressed form. In the extracting section, a plurality of still image frames are extracted at constant time intervals from the head area image data of uncompressed form. In the simple movie creating section, simple movie data is created by arranging and combining the extracted still image frames in a time series order.

When the image data of compressed form is in an intraframe compression format, the trimming section trims the head area from the image data of compressed form based on key frames.

The present invention includes an image processing program for directing a computer to perform the image processing method described above.

An image browsing system of the present invention comprises a server and a mobile terminal. The server includes the image processing device described above and transmits the simple movie created by the image processing device through a telecommunication network. The mobile terminal receives the simple movie from the server through the telecommunication network and reproduces the simple movie.

According to the present invention, the head area of the image data of the compressed form is trimmed and used to create the head area image data, which is then decoded into an uncompressed form before the extraction of the still image frames. Therefore, the amount of time for creating the simple movie in the present invention is smaller than a case in which whole of image data is decoded and then still images are extracted.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is an explanatory view showing an outline of an image browsing system using an image processing section of the present invention;

FIG. 2 is a block diagram showing an outline of the image processing section;

FIG. 3 is a flowchart showing a sequence of operation of the image processing section;

FIG. 4 is a conceptual figure showing extraction of still image frames from head area image data;

FIG. 5 is a flowchart showing a sequence of operation of an image processing section of a second embodiment;

FIG. 6 is a block diagram showing an outline of an image processing section of a third embodiment;

FIG. 7 is a flowchart showing a sequence of operation of the image processing section of the third embodiment;

FIG. 8 is a flowchart showing a sequence of operation of an image processing section of a fourth embodiment;

FIG. 9 is a flowchart showing a sequence of operation of an image processing section of a fifth embodiment; and

FIG. 10 is a flowchart showing a sequence of operation of an image processing section of a sixth embodiment;

### DETAILED DESCRIPTION OF THE PREFERRED EMBODIMENTS

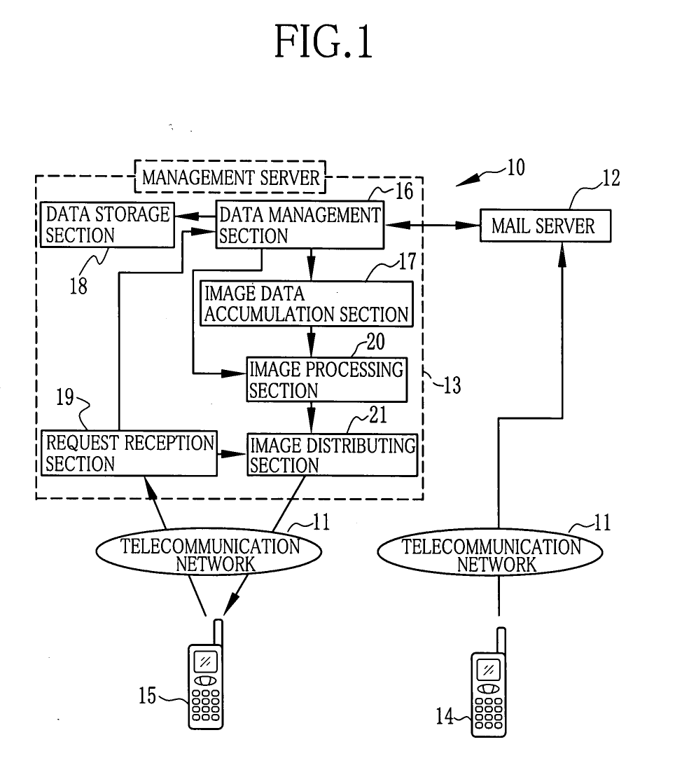

As shown in FIG. 1, an image browsing system 10 of the present invention includes a mail server 12 which can access to a telecommunication network 11 such as an internet, a management server 13 which is a computer directly connected to the mail server 12, and mobile phones 14,15 which can communicate with the management server 13 and the mail server 12 through the telecommunication network 11. The mobile phones 14, 15 have a camera function, a function for transmitting a mail with an attached movie file which contains a movie captured by this camera function, and a function for reproducing the movie file. The mail carries terminal designation information which is, specifically, an address of a sender terminal (sender address) and an address of a recipient terminal (recipient address). It is to be noted that the mobile phones 14 is a high-function terminal that supports an international movie compression standard, i.e., MPEG format. That is, the mobile phones 14 can handle irreversibly compressed digital data in which the still image frames are highly compressed. The mobile phones 15, on the other hand, is a low-functional terminal that does not support the MPEG format but supports the simple movies.

The mail server 12 receives the mail from the mobile phone 14 (sender terminal) through the telecommunication network 11, and delivers this mail to one or more recipient addresses. When the movie file is attached to the mail, the mail server 12 takes out the movie file from the mail and links the movie file to the sender address, and then sends the movie file to the management server 13. A browse address for browsing this movie file is attached to the mail to the recipient address.

The management server 13 includes a data management section 16. When receiving the movie file from the mail server 12, the data management section 16 accumulates the movie file in an image data accumulation section 17, and sends the browse address back to the mail server 12. In addition, the data management section 16 produces table data that relates the browse address to a stored location of the move file in the image data accumulation section 17, and stores this table data in a data storage section 18.

The management server 13 further includes a request reception section 19. The request reception section 19 is a section to receive a request (which contains the browse address) from the mobile terminal 15 for browsing the movie file. When receiving the request, the request reception section 19 sends the browse address to the data management section 16, which then finds the stored location of the movie file related to this browse address with referring to the data storage section 18. The data management section 16 retrieves the movie file from the data storage section 18, and inputs it to an image processing section 20. The image processing section 20 processes the input movie file to create a simple movie file, and sends the simple movie file to an image distributing section 21. Then the image distributing section 21 sends the simple movie file to the mobile phone 15. This simple movie is reproduced by a corresponding application program in the mobile phone 15.

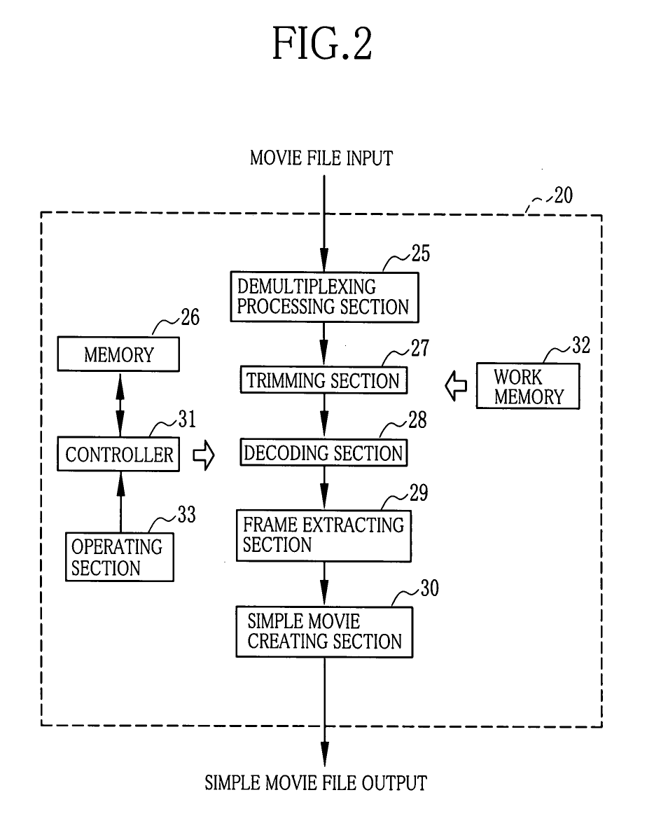

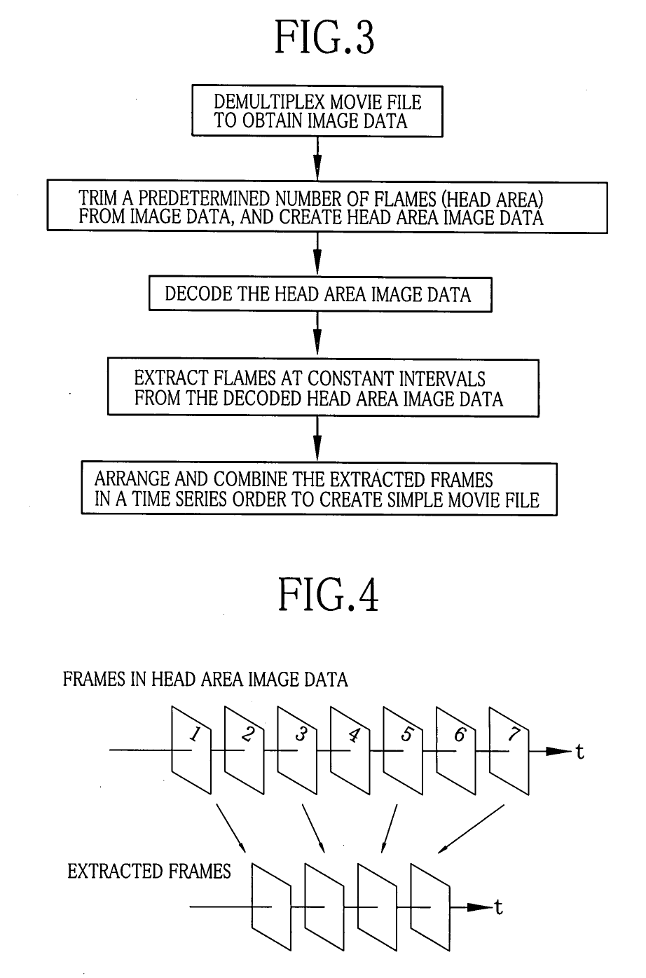

As shown in FIG. 2 and FIG. 3, the image processing section 20 includes a demultiplexing processing section 25, a memory 26, a trimming section 27, a decoding section 28, a frame extracting section 29, a simple movie creating section 30, a controller 31 and a work memory 32. The demultiplexing processing section 25 demultiplexes the movie data input from the image data accumulation section 17 into image data and audio data, and sends the image data to the trimming section 27.

For example, when video bit rate is 128 K(bps), audio bit rate is 12.2 K(bps) and frame rate is 15 (fps), a size of a MPEG file will be (128 K(bps)+12.2 K(bps))×15 (fps)/8=262.875 K(byte). When the image data is demultiplexed from the movie file, the size of the image data becomes 128 K(bps)×15 (fps)/8=240 K(byte), which is smaller than the size of the movie file. The trimming section 27 trims a head area (a predetermined number of frames from a first frame), as head area image data.

For example, if the image data is compressed by the Motion JPEG standard compression method, which is an intraframe compression allowing each frame to be decompressed independently, the image data can be trimmed on a frame (key frame) basis. If the image data is compressed by a combination of the intraframe compression and an interframe compression, the image data is trimmed on a GOP (Group Of Picture) basis which is a unit for the interframe compression.

The trimming section 27 trims a predetermined proportion of frames to whole frames in the image data of compressed form, as the head area. For example, when the proportion of a head area is determined to 50% and there are 14 frames in the image data, the first to seventh frames are trimmed as the head area.

Note that the proportion of the head area to whole image data of compressed form may be determined according to reproducing time or file size.

The decoding section 28 decodes the compressed head area image data into image data of a plurality of uncompressed still image frames. Since the decoding section 28 decodes only the head area image data trimmed from the original image data, the process can be performed more quickly than a case that whole of the image data is decoded. The frame extracting section 29 extracts a plurality of the still image frames from the image data of uncompressed form at constant time intervals.

For example, as shown in FIG. 4, when there are 7 still image frames in the image data of uncompressed form, the first, third, fifth and seventh still image frames are extracted.

The simple movie creating section 30 arranges the extracted still image frames in a time series order and combines them to create simple movie data, and outputs the simple movie data as a file in a certain format to be reproduced by a corresponding application. The simple movie file is created based on parameters, such as predetermined displaying time intervals for still image frames and so on. As kinds of files applicable for the simple movie, there are an animation GIF file in which each of still image data is compressed and connected to each other in a time series order, or a movie file (such as a file having a file extension of AVI or WMV) in which still image frames are firstly arranged in a time series order, and then combined and compressed. It is to be noted that the simple movies are not compressed by the frame compression method but by a general data compression method.

Referring back to FIG. 2, the controller 31 performs overall control of the demultiplexing processing section 25, the memory 26, the trimming section 27, the decoding section 28, the frame extracting section 29, the simple movie creating section 30 and the work memory 32. The work memory 32 is used for the processes performed in the sections 25 to 30. The memory 26 is connected to the controller 31, and memorizes designated parameters and predetermined parameters. To the controller 31, an operating section 33 is connected. The operating section 33 is used for designating or changing the proportion of the head area to be trimmed in the trimming section 27. The operating section 33 is also used for designating or changing the parameters for the simple movie creating section 30, such as predetermined displaying time intervals for still image frames and so on.

### Second Embodiment

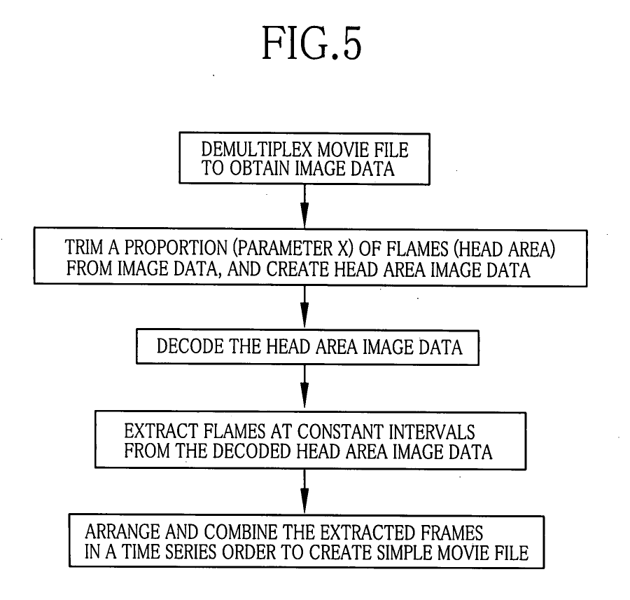

In a second embodiment, as shown in FIG. 5, a proportion (X) of still image frames in the head area image data of compressed form to whole still image frames in the image data is a parameter, while in the first embodiment the proportion of the head area to either the total number of frames, the file size or the reproducing time of the image data of compressed form is a predetermined fixed value.

The proportion (X) can be changed according to the file size of the movie file so that the file size of the head area image data becomes constant. Also, the proportion (X) can be changed according to the total number of frames in the image data so that the number of frames in the head area image data becomes constant. In other words, the proportion (X) is determined such that the file size or the number of frames after the trimming becomes a predetermined fixed value.

### Third Embodiment

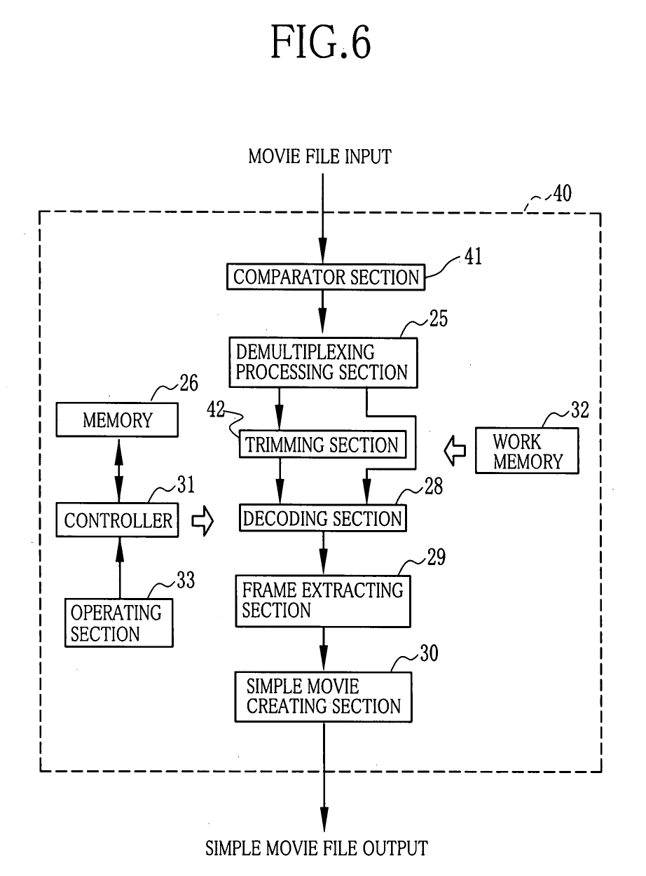

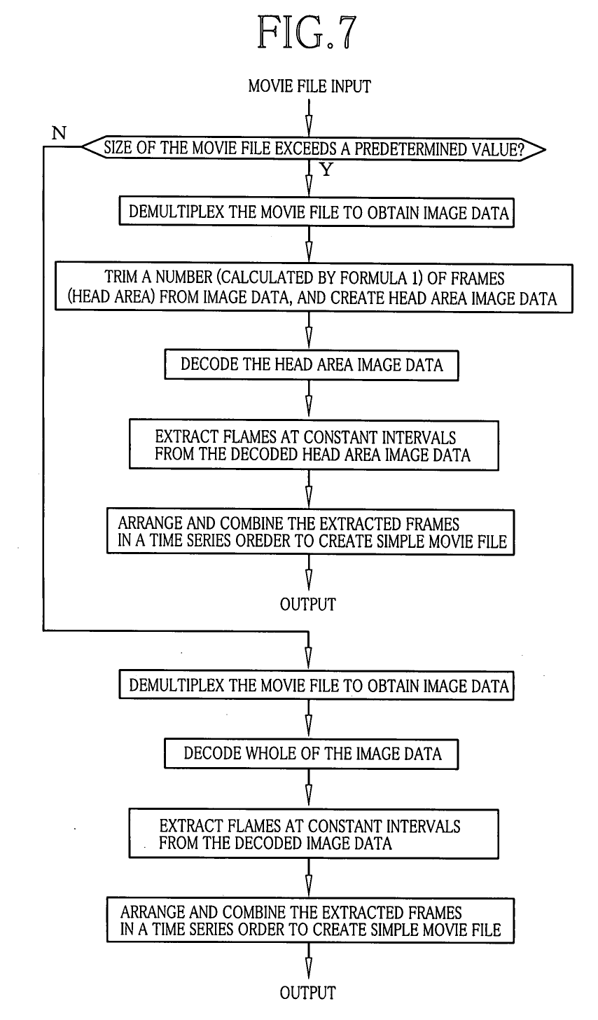

As shown in FIG. 6, an image processing section 40 of the third embodiment includes a comparator section 41. The comparator section 41 compares a size of the input image data to a threshold value (a predetermined fixed value), and sends a result to the controller 31. The controller 31 controls the trimming section 42 to trim the head area when the size of the image data is larger than the threshold value, and skip the trimming process when the size of the image data is no more than the threshold value. In addition, the controller 31 sends information of a number of frames in the head area to the trimming section 42. The number of frames in the head area is calculated according to Formula 1 below. The trimming section 42 trims the head area corresponding to the calculated number of frames to create the head area image data. Formula 1 is stored in the memory 26.

(F)=(Fn)×(Y)/(S) [Formula 1]

wherein (F) is a number of frames in the head area, (Fn) is a total number of frames in the image data after the demultiplexing process, (Y) is a file size of the head area image data after the decoding process, (S) is a file size of the input movie file (original movie file). (Y) has a value same to the threshold value. According to Formula 1, the number of frames corresponding to the file size (Y) of the decoded head area image data can be determined based on a rate between the number of frames in the movie file and the size of the movie file.

For example, when the threshold value is predetermined to 512 K(byte) in the image processing section 40, at first the comparator section 41 judges whether the size of the input movie file is larger than the threshold value (512 K(byte)) or not. When the size of the input movie file is 1 M(byte), the trimming section 42 performs the trimming process. When there are 14 frames in the image data, the number of frames in the head area becomes 7 according to Formula 1. Accordingly, the trimming section 42 trims the first to seventh frames as the head area.

In contrast, when the size of the input movie file is 256 K(byte) which is no more than the threshold value (512K (byte)), the trimming process is skipped and the whole image data is decoded by the decoding section 28 into uncompressed image data. Then a plurality of the still image frames are extracted at constant time intervals from the uncompressed image data in the frame extracting section 29, and the simple movie creating section 30 creates the simple movie file. According to this embodiment, when the size of the movie file is larger than a predetermined value, the number of frames (file size) of the simple movie can be constant.

### Fourth Embodiment

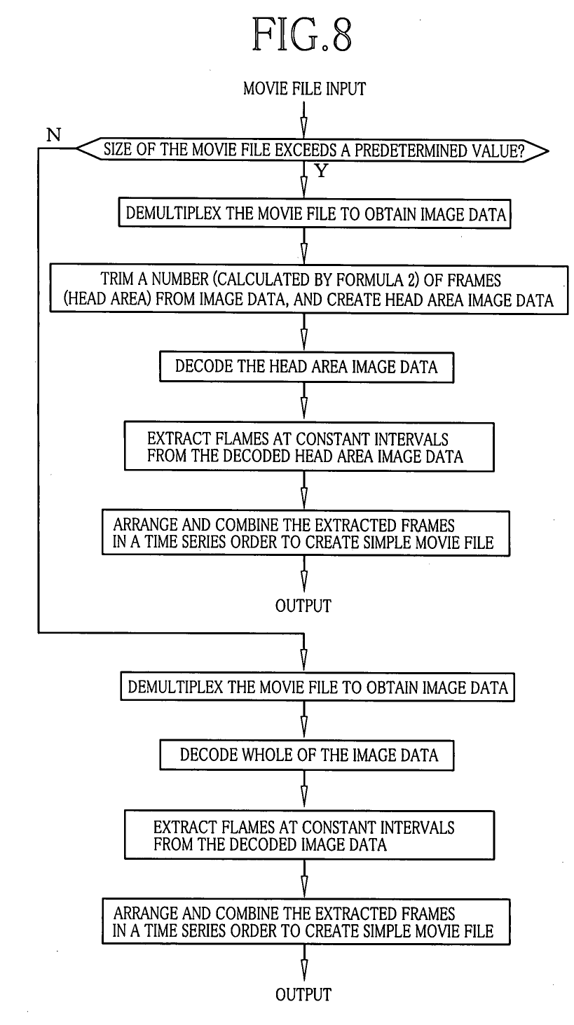

As shown in FIG. 8, also in a fourth embodiment, the trimming process is performed when the size of the image data is larger than the threshold value, and skipped when the size of the image data is no more than the threshold value. However, in the fourth embodiment, a file size of the head area image data after the decoding process is a parameter (in the third embodiment, the size is a predetermined fixed value). In the fourth embodiment, a number of frames in the head area is calculated according to Formula 2 below.

(F)=(Fn)×(Y)/(S) [Formula 2]

wherein (F) is a number of frames in the head area, (Fn) is a total number of frames in the image data after the demultiplexing process, (Y) is a file size of the head area image data after the decoding process (parameter), (S) is a file size of the input movie file (original movie file). (Y) has a value no more than the threshold value.

The file size (Y) can be changed according to a recording mode (such as a bit rate of the movie file, a video frame rate, or a combination of the two) or a file size, or according to a total number of frames in the image data after the demultiplexing process. The memory 26 stores a table that relates the file size (Y) of the decoded head area image data and elements for determining the file size (Y). The controller 31 refers to the movie file and the table to determine the file size (Y) of the decoded head area image data, and sends information of a number of frames in the head area calculated from Formula 2 to the trimming section 42. The trimming section 42 trims the calculated number of frames.

### Fifth Embodiment

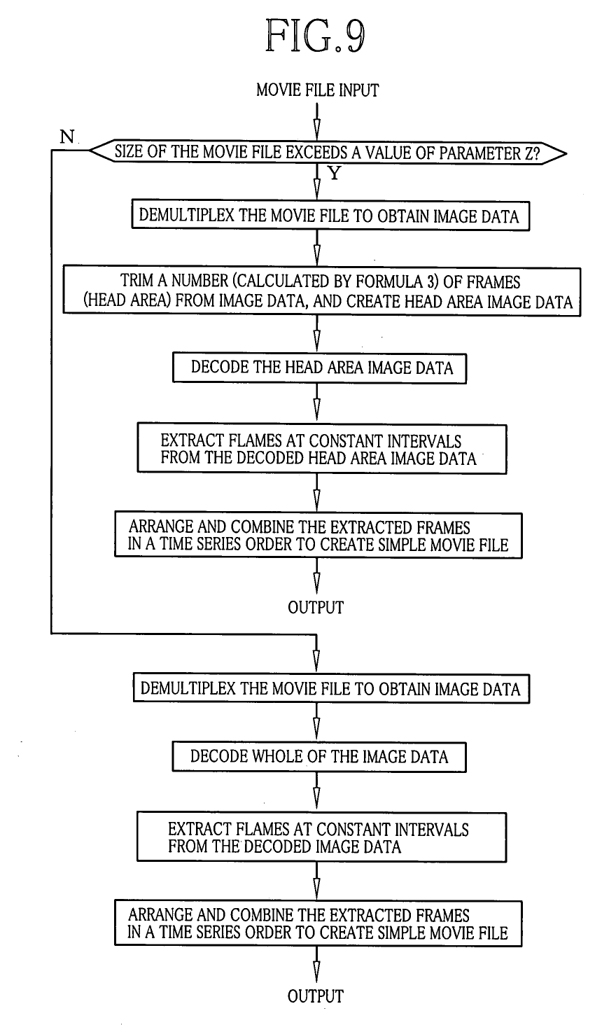

In a fifth embodiment, the threshold value is a parameter (Z) as shown in FIG. 9 (in the fourth embodiment, the threshold value is a predetermined fixed value). The threshold value (Z) can be determined according to a recording mode (such as a bit rate of the movie file, a video frame rate, or a combination of the two) or a file size of the movie file, or according to a total number of frames in the decoded image data. Further, the threshold value (Z) can be determined according to whether the simple movie file is created in a high definition image mode in which a larger amount of frames are extracted or in a low definition mode in which a smaller amount of frames are extracted.

In the fifth embodiment, a number of frames in the head area is calculated according to Formula 3 below.

(F)=(Fn)×(Z)/(S) [Formula 3]

wherein (F) is a number of frames in the head area, (Fn) is a total number of frames in the image data after the demultiplexing process, (Z) is a file size of the head area image data after the decoding process (parameter), (S) is a file size of the input movie file (original movie file). Note that the parameter (Z) takes the same value as the threshold value.

The memory 26 stores a table that relates the threshold value (Z) and elements for determining the threshold value (Z). The controller 31 refers to the movie file and the table to determine the threshold value (Z), and sends information of the determined threshold value to the comparator section 41. The comparator section 41 compares the determined threshold value and the size of the movie file, and sends the result to the controller 31. The controller 31 judges whether the trimming process is required or not, and calculates a number of frames in the head area according to Formula 3 when the trimming process is required. Then the controller 31 sends information of the calculated result to the trimming section 42. The trimming section 42 trims the calculated number of frames.

### Sixth Embodiment

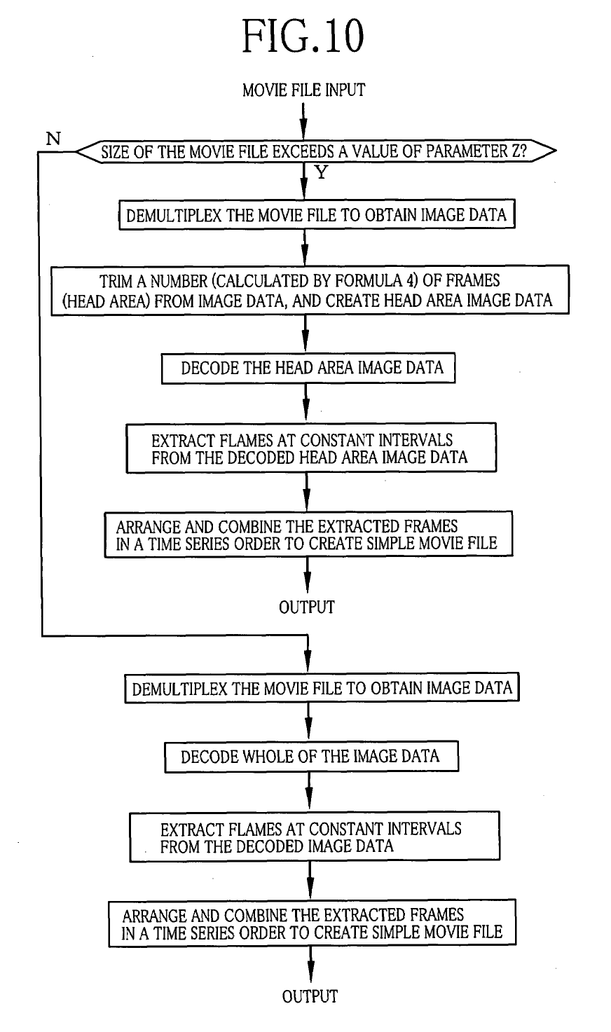

In a sixth embodiment, as shown in FIG. 10, the threshold value and the file size of the decoded head area image data are independent parameters. In the sixth embodiment, a number of frames in the head area is calculated according to Formula 4 below.

(F)=(Fn)×(Y)/(S) [Formula 4]

wherein (F) is a number of frames in the head area, (Fn) is a total number of frames in the image data after the demultiplexing process, (Y) is a file size of the head area image data after the decoding process (parameter), (S) is a file size of the input movie file (original movie file). Note that the parameter (Y) is no more than the threshold value (parameter (Z)).

The threshold value (parameter Z) can be determined according to a recording mode (such as a bit rate of the movie file, a video frame rate, or a combination of the two) or a file size of the movie file, or according to a total number of frames in the decoded image data. Further, the threshold value can be determined according to whether the simple movie file is created in a high definition image mode in which a larger amount of frames are extracted or in a low definition mode in which a smaller amount of frames are extracted.

The file size of the decoded head area image data (parameter Y) can be determined according to the same element for determining the threshold value (Z), or according to other elements.

In the above embodiments, the image processing section 20 is provided in the management server 13. However, the image processing section can be provided in an electronic device such as a mobile phone. In this case, the comparator section 41, the demultiplexing processing section 25, the trimming section 27 or 42, the decoding section 28, the frame extracting section 29, the simple movie creating section 30 of the image processing section are stored in a storage medium, and activated by a program running on a CPU. Accordingly, a movie file stored in the electronic device can be rapidly converted into a simple movie file and reproduced. In addition, this small simple movie file can be transmitted to another electronic device of low performance through the telecommunication network.

In the third to sixth embodiments, the threshold value for determining whether the trimming process is required or not is compared to the size of the movie file. However, the threshold value may be compared to a size of the image data demultiplexed from the movie file. In this case, (S) in the above Formulas 1-4 is a size of image data of compressed form, not a file size of the input movie file.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image processing method comprising:
a first step in which a series of still image frames at a head of original image data is trimmed as a head area for creating head area image data of compressed form, said original image data containing a plurality of said still image frames compressed on a frame basis;
a second step in which said head area image data of compressed form is decoded into an uncompressed form;
a third step in which a plurality of still image frames are extracted from said head area image data of uncompressed form, said extracted still image frames having constant time intervals; and
a fourth step in which simple movie data is created by arranging and combining said extracted still image frames in a time series order.

2. An image processing method claimed in claim 1, wherein a proportion of still image frames in said head area image data of compressed form to whole still image frames in said image data is predetermined.

3. An image processing method claimed in claim 1, wherein a proportion of still image frames in said head area image data of compressed form to whole still image frames in said image data is changed according to said size of said image data or a number of said still image frames in said image data.

4. An image processing method claimed in claim 1, further comprising a step of comparing a size of said image data to a threshold value before said first step,
wherein said head area is trimmed in said first step only when said size of said image data is larger than said threshold value so that a size of said head area image data of uncompressed form becomes no more than said threshold value.

5. An image processing method claimed in claim 4, wherein a number of still image frames corresponding to a size of said head area image data of uncompressed form is trimmed as said head area in said first step, based on a rate between a number of still image frames in said image data and a size of said image data.

6. An image processing method claimed in claim 4, wherein said threshold value is a predetermined fixed value.

7. An image processing method claimed in claim 6, wherein a size of said head area image data of uncompressed form is equal to said threshold value.

8. An image processing method claimed in claim 6, wherein a size of said head area image data of uncompressed form is variable in a range no more than said threshold value.

9. An image processing method claimed in claim 4, wherein said threshold value is variable.

10. An image processing method claimed in claim 9, wherein a size of said head area image data of uncompressed form is equal to said threshold value.

11. An image processing method claimed in claim 9, wherein a size of said head area image data of uncompressed form is variable in a range no more than said threshold value.

12. An image processing device comprising:
a trimming section in which a series of still image frames at a head of original image data is trimmed as a head area for creating head area image data of compressed form, said original image data containing a plurality of said still image frames compressed on a frame basis;
a decoding section in which said head area image data of compressed form is decoded into an uncompressed form;
an extracting section in which a plurality of still image frames are extracted from said head area image data of uncompressed form, said extracted still image frames having constant time intervals; and
a simple movie creating section in which simple movie data is created by arranging and combining said extracted still image frames in a time series order.

13. An image processing device claimed in claim 12 further comprising:
a comparator section which compares a size of said image data to a threshold value before said first step,
wherein said head area is trimmed in said comparator section only when said size of said image data is larger than said threshold value so that a size of said head area image data of uncompressed form becomes no more than said threshold value.

14. An image processing device claimed in claim 12′, wherein said image data of compressed form is in an intraframe compression format, and wherein said trimming section trims said head area from said image data of compressed form based on key frames.

15. An image processing program for directing a computer to perform said image processing method claimed in claim 1.

16. An image browsing system comprising:
a server including said image processing device claimed in claim 12, for transmitting said simple movie created by said image processing device through a telecommunication network; and
a mobile terminal which receives said simple movie from said server through said telecommunication network and reproduces said simple movie.
